(19) United States
(12) Patent Application Publication
(10) Pub. No.: US 2022/0098422 A1
(43) Pub. Date: Mar. 31, 2022

(54) Radiation-Curable Ink Jet Composition, Ink Jet Method, And Recorded Matter

(71) Applicant: Seiko Epson Corporation, Tokyo (JP)

(72) Inventor: Chigusa SATO, Shiojiri (JP)

(21) Appl. No.: 17/488,580

(22) Filed: Sep. 29, 2021

(30) Foreign Application Priority Data
Sep. 30, 2020 (JP) 2020-165267

(51) Int. Cl. C09D 11/101; C09D 11/322; C09D 11/38; C08K 3/22; C08F 2/48; C08F 222/10; B41J 11/00

(52) U.S. Cl. CPC C09D 11/101; C09D 11/322; C09D 11/38; C08K 3/22; C08K 2201/003; C08F 222/102; C08F 222/103; B41J 11/00214; C08K 2003/2241; C08F 2/48

(57) ABSTRACT

A radiation-curable ink jet composition includes titanium oxide, a polymerizable compound, and a photopolymerization initiator, in which the titanium oxide has an average particle diameter of equal to or more than 250 nm and equal to or less than 400 nm, and the polymerizable compound contains a vinyl group-containing (meth)acrylate represented by the following formula (I).

H₂C═CR¹—CO—OR²—O—CH═CH—R³ (I)
(wherein R¹ represents a hydrogen atom or a methyl group, R² represents a divalent organic residue having 2 to 20 carbon atoms, and R³ represents a hydrogen atom or a monovalent organic residue having 1 to 11 carbon atoms.)

The present application is based on, and claims priority from JP Application Serial Number 2020-165267, filed Sep. 30, 2020, the disclosure of which is hereby incorporated by reference herein in its entirety.

### BACKGROUND

### 1. Technical Field

The present disclosure relates to a radiation-curable ink jet composition, an ink jet method, and a recorded matter.

### 2. Related Art

In recent years, development of radiation-curable ink jet compositions that are cured by ultraviolet rays, electron beams, or other radiation has been advanced. Such a radiation-curable ink has quick-drying properties in recording on a recording medium such as plastic, glass, or coated paper that does not absorb ink or hardly absorbs ink, and can realize recording in which ink bleeding is prevented.

According to a radiation-curable white ink containing a white pigment such as titanium oxide as a coloring material, by printing on a recording medium using the radiation-curable white ink as a base, a color expression suitable for an image can be achieved without being affected by the color or pattern of the recording medium.

For example, International Publication No. WO 2006/035679 discloses a photocurable white ink jet composition containing titanium oxide having an average particle diameter of equal to or less than 250 nm.

However, in the photocurable white ink jet composition described in International Publication No. WO 2006/035679, since the average particle diameter of the titanium oxide used is relatively small and a light scattering rate is low, it has been difficult to obtain sufficient shielding properties when a film thickness of a cured coating film formed on the recording medium is small.

As a result of detailed studies by the present applicant, it was found that when the average particle diameter of titanium oxide is within a specific range, the shielding property is improved, and sufficient shielding property can be obtained without increasing the thickness of the cured coating film. However, when titanium oxide having an average particle diameter within such a specific range is contained, the viscosity of the ink composition increases, and the storage stability and ink jet suitability deteriorate. Therefore, it is required to satisfy both of excellent shielding properties enabling sufficient shielding properties to be secured even when the film thickness of the cured coating film formed on the recording medium is small and suppression of the viscosity of the ink composition to a low level.

### SUMMARY

An aspect of a radiation-curable ink jet composition according to the present disclosure is a radiation-curable ink jet composition including titanium oxide, a polymerizable compound, and a photopolymerization initiator, in which an average particle diameter of the titanium oxide is equal to or more than 250 nm and equal to or less than 400 nm, and the polymerizable compound contains a vinyl group-containing (meth)acrylate represented by the following formula (I).

H₂C═CR¹—CO—OR²—O—CH═CH—R³ (I)
(wherein R¹ represents a hydrogen atom or a methyl group, R² represents a divalent organic residue having 2 to 20 carbon atoms, and R³ represents a hydrogen atom or a monovalent organic residue having 1 to 11 carbon atoms.)

An aspect of an ink jet method according to the present disclosure is an ink jet method including: a discharging step of discharging the radiation-curable ink jet composition of the above aspect from an ink jet head to a recording medium; and a curing step of irradiating the discharged radiation-curable ink jet composition with radiation to obtain a cured coating film of the radiation-curable ink jet composition, in which a maximum film thickness of the cured coating film is equal to or less than 15 μm.

An aspect of a recorded matter according to the present disclosure is a recorded matter in which a cured coating film of a radiation-curable ink jet composition is formed on a recording medium, in which the cured coating film contains titanium oxide particles having an average particle diameter of equal to or more than 250 nm and equal to or less than 400 nm, and a maximum film thickness of the cured coating film is equal to or less than 15 μm.

### BRIEF DESCRIPTION OF THE DRAWINGS

FIG. 1 is a perspective view of an ink jet recording apparatus that can be used in an ink jet method according to the embodiment.

FIG. 2 is a front view of a light irradiation device illustrated in FIG. 1.

FIG. 3 is a view taken along a line III-III of FIG. 2.

### DESCRIPTION OF EXEMPLARY EMBODIMENTS

Hereinafter, embodiments of the present disclosure will be described. The embodiments described below are illustrative of examples of the present disclosure. The present disclosure is not limited to the following embodiments at all, and includes various modified embodiments implemented within a range that does not change the gist of the present disclosure. It should be noted that not all of the configurations described below are essential configurations of the present disclosure.

### 1. Radiation-Curable Ink Jet Composition

A radiation-curable ink jet composition according to an embodiment of the present disclosure (hereinafter, also simply referred to as an “ink composition”) is a radiation-curable ink jet composition including titanium oxide, a polymerizable compound, and a photopolymerization initiator, in which an average particle diameter of the titanium oxide is equal to or more than 250 nm and equal to or less than 400 nm, and the polymerizable compound contains a vinyl group-containing (meth)acrylate represented by the following formula (I).

H₂C═CR¹—CO—OR²—O—CH═CH—R³ (I)

(wherein R¹ represents a hydrogen atom or a methyl group, R² represents a divalent organic residue having 2 to 20 carbon atoms, and R³ represents a hydrogen atom or a monovalent organic residue having 1 to 11 carbon atoms.)

According to the radiation-curable ink jet composition of the embodiment, by including titanium oxide having an average particle diameter within a specific range, the shielding property can be improved. In addition, by including the specific polymerizable compound having low viscosity, the viscosity of the ink composition can be suppressed to be low. Therefore, it is possible to realize both excellent shielding properties enabling sufficient shielding properties to be secured and suppression of the viscosity of the ink composition to a low level without increasing the film thickness of the cured coating film on the recording medium.

Hereinafter, each component contained in the radiation-curable ink jet composition according to the embodiment will be described.

### 1.1. Titanium Oxide

The radiation-curable ink jet composition according to the embodiment contains titanium oxide. The titanium oxide may be, for example, a modified titanium oxide whose surface is modified with a surface modifier or an unmodified titanium oxide, but is preferably a surface-modified titanium oxide from the viewpoint of dispersibility and weather resistance.

The form of the titanium oxide is not particularly limited, and examples thereof include an amorphous form, an anatase-type crystal form, and a rutile-type crystal form, and the rutile-type crystal form is preferable from the viewpoint of further improving the shielding property.

As the titanium oxide, a commercially available product may be used, and examples of the commercially available product include CR-50, CR-50-2, CR-57, CR-Super70, CR-80, CR-90, CR-90-2, CR-93, CR-95, CR-953, CR-97, R-820, R-830, R-930, UT771, PFC105 (trade names, manufactured by Ishihara Sangyo Kaisha, Ltd.), and R-38L (trade name, manufactured by Sakai Chemical Industry Co., Ltd.). These commercially available products can be used alone or in combination of two or more.

The average particle diameter of titanium oxide is equal to or more than 250 nm and equal to or less than 400 nm, preferably equal to or more than 270 nm and equal to or less than 380 nm, and more preferably equal to or more than 290 nm and equal to or less than 360 nm. When the average particle diameter of the titanium oxide is within the above range, the shielding property can be improved.

In the present disclosure, the “average particle diameter” refers to a particle diameter at a cumulative 50% in a volume-based particle size distribution determined by a laser diffraction/scattering method. The average particle diameter is measured by a dynamic light scattering method or a laser diffraction method described in JIS Z8825. Specifically, a particle size distribution meter using a dynamic light scattering method as a measurement principle, for example, trade name “Microtrac UPA” manufactured by Nikkiso Co., Ltd. can be used.

The content of titanium oxide is preferably equal to or less than 20% by mass, more preferably equal to or less than 19% by mass, and particularly preferably equal to or less than 18% by mass with respect to the total amount of the radiation-curable ink jet composition. The ink composition according to the embodiment tends to obtain excellent shielding properties even when the content of titanium oxide is within the above range. That is, since excellent shielding properties can be ensured even titanium oxide is not contained in an amount exceeding the above range, the viscosity of the ink composition can be suppressed to be low.

### 1.2. Polymerizable Compound

The radiation-curable ink jet composition according to the embodiment contains a polymerizable compound. The polymerizable compound can be used alone or polymerized by the action of a photopolymerization initiator upon irradiation with radiation to cure the ink on the recording medium. The polymerizable compound contains a vinyl group-containing (meth)acrylate represented by the following formula (I) from the viewpoint that the viscosity of the ink composition can be further reduced, a flash point is high, and the curability of the ink composition is further improved.

H₂C═CR¹—CO—OR²—O—CH═CH—R³ (I)
(wherein R¹ represents a hydrogen atom or a methyl group, R² represents a divalent organic residue having 2 to 20 carbon atoms, and R³ represents a hydrogen atom or a monovalent organic residue having 1 to 11 carbon atoms.)

Hereinafter, the vinyl group-containing (meth)acrylate represented by the formula (I) may be simply referred to as a “compound of the formula (I)”. In addition, in the present specification, “(meth)acrylate” means at least one of acrylate and methacrylate corresponding thereto, “(meth)acryl” means at least one of acryl and methacryl corresponding thereto, and “(meth)acryloyl” means at least one of acryloyl and methacryloyl corresponding thereto.

When the ink composition according to the embodiment contains the compound of the formula (I), the viscosity of the ink composition can be further reduced. Therefore, even in the case of an ink composition containing titanium oxide having an average particle diameter within the specific range described above, the viscosity can be suppressed to be low by containing the compound of the formula (I).

The polymerizable compound other than the compound of the above formula (I) is not particularly limited, and specifically, known monofunctional, bifunctional, trifunctional, and higher polyfunctional monomers and oligomers can be used. The term “oligomer” refers to a low polymer having a weight average molecular weight of equal to or less than 10,000, which is a dimer or more obtained by polymerization of monomers. As the weight average molecular weight in the present specification, a value obtained by measurement by mass spectrometry is adopted.

The polymerizable compound may be used alone or in combination of two or more kinds thereof. Hereinafter, these polymerizable compounds will be exemplified.

### 1.2.1. Vinyl Group-Containing (Meth)Acrylates

In the above formula (I), examples of the divalent organic residue having 2 to 20 carbon atoms represented by R² include a linear, branched or cyclic alkylene group having 2 to 20 carbon atoms, which may be substituted, an alkylene group having 2 to 20 carbon atoms, which may be substituted and has at least one ether bond and ester bond in the structure, and a divalent aromatic group having 6 to 11 carbon atoms, which may be substituted.

Among these, an alkylene group having 2 to 6 carbon atoms, such as an ethylene group, an n-propylene group, an isopropylene group, and a butylene group, and an alkylene group having 2 to 9 carbon atoms and having an oxygen atom through an ether bond in the structure, such as an oxyethylene group, an oxy-n-propylene group, an oxyisopropylene group, and an oxybutylene group are preferable. Furthermore, from the viewpoint of lowering the viscosity of the ink and improving the curability of the ink, those having glycol ether chains are more preferable, in which R² is an alkylene group having 2 to 9 carbon atoms and having an oxygen atom through an ether bond in the structure such as an oxyethylene group, an oxy-n-propylene group, an oxyisopropylene group, and an oxybutylene group.

In the above formula (I), examples of the monovalent organic residue having 1 to 11 carbon atoms represented by R³ include a linear, branched or cyclic alkyl group having 1 to 10 carbon atoms, which may be substituted, and an aromatic group having 6 to 11 carbon atoms, which may be substituted. Among them, an alkyl group having 1 to 2 carbon atoms, which is a methyl group or an ethyl group, and an aromatic group having 6 to 8 carbon atoms, such as a phenyl group and a benzyl group, are preferable.

When each organic residue is an optionally substituted group, the substituent group is classified into a group containing a carbon atom and a group containing no carbon atom. When the substituent group is the group containing a carbon atom, the carbon atom is counted as the number of carbon atoms of the organic residue. The group containing a carbon atom is not particularly limited, and examples thereof include a carboxy group and an alkoxy group. The group containing no carbon atom is not particularly limited, and examples thereof include a hydroxyl group and a halo group.

Specific examples of the compound represented by the formula (I) include, but are not particularly limited to, for example, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl methacrylate, 2-(2-vinyloxyethoxy)ethyl acrylate (VEEA), 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. Among these specific examples, VEEA: 2-(2-vinyloxyethoxy)ethyl acrylate is particularly preferable from the viewpoint of easy to balance between curability and viscosity in the ink composition.

The content of the compound of the formula (I) is preferably equal to or more than 10% by mass and equal to or less than 50% by mass, more preferably equal to or more than 20% by mass and equal to or less than 40% by mass, and particularly preferably equal to or more than 25% by mass and equal to or less than 35% by mass with respect to the total amount of the radiation-curable ink jet composition. When the content of the compound of the formula (I) is equal to or more than 10% by mass, the viscosity of the ink composition can be reduced, and the curability of the ink composition can be made more excellent. On the other hand, when the content is equal to or less than 50% by mass, the storage stability of the ink composition can be maintained in an excellent state, and an abrasion resistance and the stretchability can be improved.

### 1.2.2. Other Polymerizable Compounds

The radiation-curable ink jet composition according to the embodiment may further include a monomer having a property of being polymerized by a polymerization initiator as the polymerizable compound. As such a monomer, various monofunctional, bifunctional or higher functional monomers and oligomers can be used. Examples of the monomer include, for example, unsaturated carboxylic acids such as (meth)acrylic acid, itaconic acid, crotonic acid, isocrotonic acid and maleic acid, salts or esters thereof, urethanes, amides and anhydrides thereof, acrylonitrile, styrene, various unsaturated polyesters, unsaturated polyethers, unsaturated polyamides, unsaturated urethanes, and the like.

Examples of the oligomer include, for example, oligomers formed from the above monomers, such as linear (meth)acrylic oligomers, epoxy (meth)acrylate, oxetane (meth)acrylate, aliphatic urethane (meth)acrylate, aromatic urethane (meth)acrylate, and polyester (meth)acrylate or the like.

Examples of the monofunctional (meth)acrylate include, for example, isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, tetrahydrofurfuryl acrylate (THFA), tetrahydrofurfuryl methacrylate, isobornyl (meth)acrylate, 2-hydroxyethyl (meth)acrylate, 2-hydroxypropyl (meth)acrylate, lactone-modified flexible (meth)acrylate, t-butylcyclohexyl (meth)acrylate, dicyclopentanyl (meth) acrylate, and dicyclopentenyloxyethyl (meth)acrylate.

Examples of the bifunctional (meth)acrylate include, for example, 1,6-hexanediol di(meth)acrylate, 1,10-decanediol di(meth)acrylate, 2,4-dimethyl-1,5-pentanediol di(meth)acrylate, ethoxylated cyclohexanemethanol di(meth)acrylate, polyethylene glycol di(meth)acrylate, oligoethylene glycol di(meth)acrylate, 2-ethyl-2-butyl-butanediol di(meth)acrylate, hydroxypivalic acid neopentyl glycol di(meth)acrylate, EO (ethylene oxide)-modified bisphenol A di(meth)acrylate, bisphenol F polyethoxy di(meth)acrylate, polyethylene glycol di(meth)acrylate, polypropylene glycol di(meth)acrylate, oligopropylene glycol di(meth)acrylate, 2-ethyl-2-butylpropanediol di(meth)acrylate, 1,9-nonanediol di(meth)acrylate, propoxylated ethoxylated bisphenol A di(meth)acrylate, tricyclodecane di(meth)acrylate, polytetramethylene glycol di(meth)acrylate, an acrylated amine compound obtained by reacting 1,6-hexanediol di(meth)acrylate with an amine compound, tricyclodecanedimethylol di(meth)acrylate, EO (ethylene oxide) adduct di(meth)acrylate of bisphenol A, PO (propylene oxide) adduct di(meth)acrylate of bisphenol A, or the like.

Examples of the trifunctional (meth)acrylate include, for example, trimethylolpropane tri(meth)acrylate, trimethylolethane tri(meth)acrylate, alkylene oxide-modified trimethylolpropane tri(meth)acrylate, pentaerythritol tri(meth)acrylate, dipentaerythritol tri(meth)acrylate, trimethylolpropane tri((meth)acryloyloxypropyl) ether, isocyanuric acid alkylene oxide-modified tri(meth)acrylate, dipentaerythritol propionate tri(meth)acrylate, tri((meth)acryloyloxyethyl)isocyanurate, hydroxypivalaldehyde-modified dimethylolpropane tri(meth)acrylate, sorbitol tri(meth)acrylate, glycerin propoxy tri(meth)acrylate, propoxylated trimethylolpropane tri(meth)acrylate, ethoxylated glycerin triacrylate, and caprolactone-modified trimethylolpropane tri(meth)acrylate.

Examples of the tetrafunctional (meth)acrylate include, for example, pentaerythritol tetra(meth)acrylate, sorbitol tetra(meth)acrylate, ditrimethylolpropane tetra(meth)acrylate, dipentaerythritol propionate tetra(meth)acrylate, and ethoxylated pentaerythritol tetra(meth)acrylate.

Examples of the pentafunctional (meth)acrylate include sorbitol penta(meth)acrylate, dipentaerythritol penta(meth)acrylate, ditrimethylolpropane penta(meth)acrylate, propionic acid-modified dipentaerythritol penta(meth)acrylate, propionic acid-modified tripentaerythritol penta(meth)acrylate, propionic acid-modified tetrapentaerythritol penta(meth)acrylate, and ethylene oxide (EO) adducts thereof and propylene oxide (PO) adducts thereof, or the like.

Examples of the hexafunctional (meth)acrylate include sorbitol hexa(meth)acrylate, ditrimethylolpropane hexa(meth)acrylate, dipentaerythritol hexa(meth)acrylate, tripentaerythritol hexa(meth)acrylate, alkylene oxide-modified phosphazene hexa(meth)acrylate, caprolactone-modified dipentaerythritol hexa(meth)acrylate, propionic acid-modified tripentaerythritol hexa(meth)acrylate, propionic acid-modified tetrapentaerythritol hexa(meth)acrylate, and EO adducts thereof and PO adducts thereof, or the like.

Examples of the heptafunctional or higher functional (meth)acrylate include tripentaerythritol hepta(meth)acrylate, propionic acid-modified tripentaerythritol hepta(meth)acrylate, propionic acid-modified tetrapentaerythritol hepta(meth)acrylate, tripentaerythritol octa(meth)acrylate, propionic acid-modified tetrapentaerythritol octa(meth)acrylate, tetrapentaerythritol nona(meth)acrylate, propionic acid-modified tetrapentaerythritol nona(meth)acrylate, tetrapentaerythritol deca(meth)acrylate, pentapentaerythritol undeca(meth)acrylate, pentapentaerythritol dodeca(meth)acrylate, and EO adducts thereof and PO adducts thereof, or the like.

Examples of the compound belonging to glycol-based di(meth)acrylate include ethylene glycol di(meth)acrylate, diethylene glycol di(meth)acrylate, triethylene glycol di(meth)acrylate, tetraethylene glycol di(meth)acrylate, propylene glycol di(meth)acrylate, dipropylene glycol di(meth)acrylate, tripropylene glycol di(meth)acrylate, 1,4-butanediol di(meth)acrylate, 1,3-butanediol di(meth)acrylate, dibutylene glycol di(meth)acrylate, tributylene glycol di(meth)acrylate, tetrabutylene glycol di(meth)acrylate, 1,5-pentanediol di(meth)acrylate, 1,4-pentanediol di(meth)acrylate, 1,3-pentanediol di(meth)acrylate, dipentylene glycol di(meth)acrylate, tripentylene glycol di(meth)acrylate, cyclopentanediol di(meth)acrylate, neopentyl glycol di(meth)acrylate, and the like.

Among the monomers described above, the (meth)acrylates may have one or more skeletons selected from saturated alicyclic skeletons and unsaturated alicyclic skeletons. By having such a skeleton, the glass transition temperature of the cured product can be adjusted. Examples of the (meth)acrylate having a saturated alicyclic skeleton include, for example, isobornyl acrylate (IBXA), isobornyl methacrylate, t-butylcyclohexyl (meth)acrylate, and dicyclopentanyl (meth)acrylate. Examples of the (meth)acrylate having an unsaturated alicyclic skeleton include, for example, dicyclopentenyloxyethyl (meth)acrylate.

Among the above monomers, the (meth)acrylates may have an aromatic ring skeleton. Examples of the (meth)acrylate compound having an aromatic ring skeleton include, for example, phenoxyethyl acrylate (PEA), phenoxyethyl methacrylate, 2-hydroxy-3-phenoxypropyl (meth)acrylate, benzyl (meth)acrylate, and phenoxydiethylene glycol (meth)acrylate, nonylphenoxyethyl (meth)acrylate, alkoxylated phenoxyethyl (meth)acrylate, and the like.

These other polymerizable compounds described above may be used alone or in combination of two or more kinds thereof. The lower limit of the total content of the other polymerizable compounds is not limited, but is equal to or more than 20% by mass, and preferably equal to or more than 30% by mass, with respect to the total amount of the radiation-curable ink jet composition. The upper limit of the total content of the other polymerizable compounds is not limited, but is equal to or less than 60% by mass, and preferably equal to or less than 55% by mass, with respect to the total amount of the radiation-curable ink jet composition. When the total content of the other polymerizable compounds is within the above range, the curability and viscosity of the ink composition tend to be appropriate.

### 1.3. Photopolymerization Initiator

The photopolymerization initiator contained in the radiation-curable ink jet composition according to the embodiment is used to form a print by curing the ink composition through polymerization by irradiation with radiation such as ultraviolet light or visible light. By using ultraviolet rays (UV) as the radiation, safety is excellent and the cost of a light source lamp can be suppressed. There is no limitation as long as active species such as radicals and cations are generated by energy of radiation such as ultraviolet rays to initiate polymerization of the above-described polymerizable compound, but a radical polymerization initiator or a cationic polymerization initiator can be used, and among them, a radical polymerization initiator is preferably used.

Examples of the radical polymerization initiator described above include, for example, aromatic ketones, an acylphosphine oxide-based compound, an aromatic onium salt compound, an organic peroxide, a thio compound (such as a thioxanthone compound or a thiophenyl group-containing compound), a hexaarylbiimidazole compound, a ketoxime ester compound, a borate compound, an azinium compound, a metallocene compound, an active ester compound, a compound having a carbon-halogen bond, and alkyl amine compounds.

Among these, particularly, at least one of an acylphosphine oxide-based compound and a thioxanthone compound is preferable, and an acylphosphine oxide-based compound and a thioxanthone compound are more preferable, because the curability of the radiation-curable ink jet composition can be improved.

Specific examples of the radical polymerization initiator include acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, bis(2,4,6-trimethylbenzoyl)-phenylphosphine oxide, 2,4,6-trimethylbenzoyl-diphenyl-phosphine oxide, 2,4-diethylthioxanthone, and bis-(2,6-dimethoxybenzoyl)-2,4,4-trimethylpentylphosphine oxide.

Among them, 2,4,6-trimethylbenzoyl-diphenyl-phosphine oxide, bis(2,4,6-trimethylbenzoyl)-phenylphosphine oxide and 2,4-diethylthioxanthone are preferably used, and 2,4,6-trimethylbenzoyl-diphenyl-phosphine oxide and bis(2,4,6-trimethylbenzoyl)-phenylphosphine oxide are preferably used in combination.

Examples of commercially available products of the radical polymerization initiator include, for example, IRGACURE 651 (2,2-dimethoxy-1,2-diphenylethan-1-one), IRGACURE 184 (1-hydroxy-cyclohexyl-phenyl-ketone), DAROCUR 1173 (2-hydroxy-2-methyl-1-phenyl-propan-1-one), IRGACURE 2959 (1-[4-(2-hydroxyethoxy)-phenyl]-2-hydroxy-2-methyl-1-propan-1-one), IRGACURE 127 (2-hydroxy-1-{4-[4-(2-hydroxy-2-methyl-propionyl)-benzyl] phenyl}-2-methyl-propan-1-one), IRGACURE 907 (2-methyl-1-(4-methylthiophenyl)-2-morpholinopropan-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)-phenylphosphine oxide), IRGACURE TPO (2,4,6-trimethylbenzoyldiphenylphosphine oxide), IRGACURE 784 (bis(n5-2,4-cyclopentadien-1-yl)-bis(2,6-difluoro-3-(1H-pyrrol-1-yl)-phenyl)titanium), IRGACURE OXE 01 (1,2-octanedione, 1-[4-(phenylthio)-, 2-(O-benzoyloxime)]), IRGACURE OXE 02 (ethanone, 1-[9-ethyl-6-(2-methylbenzoyl)-9H-carbazol-3-yl]-, 1-(0-acetyloxime)), IRGACURE 754 (a mixture of oxyphenylacetic acid, 2-[2-oxo-2-phenylacetoxyethoxy]ethyl ester and oxyphenylacetic acid, 2-(2-hydroxyethoxy)ethyl ester) (trade names, manufactured by BASF), KAYACURE DETX-S(2,4-diethylthioxanthone) (trade name, manufactured by Nippon Kayaku Co., Ltd.), Lucirin TPO, LR8893, LR8970 (trade names, manufactured by BASF), and Ubecryl P36 (trade name, manufactured by UCB).

The above-described photopolymerization initiators may be used alone or in combination of two or more kinds thereof.

The content of the photopolymerization initiator is preferably equal to or more than 1% by mass and equal to or less than 20% by mass, more preferably equal to or more than 2% by mass and equal to or less than 15% by mass, and even more preferably equal to or more than 3% by mass and equal to or less than 10% by mass, with respect to the total amount of the radiation-curable ink jet composition, in order to improve the curability of the radiation-curable ink jet composition and to prevent the photopolymerization initiator from remaining undissolved and coloring due to the photopolymerization initiator.

### 1.4. Other Components

The radiation-curable ink jet composition according to the embodiment may contain components other than the components described above. Examples of such components are given below.

### Inorganic Particles

The radiation-curable ink jet composition according to the embodiment may further include inorganic particles. Since titanium oxide has a high density, there is a problem in that titanium oxide is easily precipitated in the ink composition. When such an ink composition is left to stand for a long period of time, the precipitated titanium oxide particles are fixed to each other and re-dispersion becomes difficult (hereinafter, this state is also referred to as “hard caking”), and the viscosity of the ink composition also tends to increase. On the other hand, since the radiation-curable ink composition according to the embodiment further includes the inorganic particles, the inorganic particles function as a spacer, and it is possible to reduce the chance of direct contact between titanium oxides. As a result, even when the titanium oxide is precipitated, hard caking can be suppressed, and the titanium oxide can be rapidly re-dispersed by simple stirring, so that excellent precipitation recovery properties tend to be obtained. In the present disclosure, the “inorganic particles” refer to particles other than titanium oxide contained in the ink composition described above.

The inorganic particles is not particularly limited as long as they fulfill functions as the above-described spacer, and examples thereof include white inorganic particles such as precipitated calcium carbonate, ground calcium carbonate, kaolin, talc, calcium sulfate, barium sulfate, zinc oxide, zinc sulfide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, alumina, lithopone, zeolite, hydrated halloysite, magnesium carbonate, magnesium hydroxide, and the like.

Among the inorganic particles described above, silica particles and alumina particles are preferable, and silica particles are more preferable. For example, it is considered that when silica particles are added, a functional group (for example, a silanol group) present on the surface thereof and a hydroxyl group of titanium oxide are adsorbed to each other by a hydrogen bond or the like, and a further favorable effect as a spacer is exhibited. In addition, since the density of the silica particles is smaller than that of the titanium oxide, a further favorable effect as a spacer is exhibited.

Examples of the silica particles include fumed silica synthesized by reacting silicon chloride, aluminum chloride, titanium chloride or the like with oxygen and hydrogen in a vapor phase by a fumed method; silica synthesized by hydrolyzing and condensing a metal alkoxide by a sol-gel method; and colloidal silica synthesized by an inorganic colloid method or the like, and one or more kinds thereof can be used. Among them, colloidal silica is more preferable. As such colloidal silica, commercially available products can also be used, and examples thereof include Quartron PL-1-1PA and PL-2L-MEK manufactured by Fuso Chemical Co., Ltd., and organosilica sol MA-ST-L, IPA-ST-L, IPA-ST-ZL, and the like manufactured by Nissan Chemical Corporation.

The alumina particles may have any of a rod shape, a beaded shape, and a spherical shape, but spherical colloidal alumina is preferably used.

The average particle diameter of the inorganic particles is not particularly limited, but is preferably equal to or more than 10 nm and less than 200 nm, more preferably greater than 25 nm and equal to or less than 150 nm, even more preferably greater than 25 nm and equal to or less than 120 nm, and particularly preferably equal to or more than 40 nm and equal to or less than 100 nm. When the average particle diameter of the inorganic particles is within the above range, the function as a spacer tends to be effectively exhibited without changing the color tone of the ink.

The average particle diameter of the inorganic particles with respect to the average particle diameter of the titanium oxide is preferably equal to or more than 15% and less than 30%, more preferably equal to or more than 15% and less than 25%, and particularly preferably equal to or more than 15% and less than 20%. When the average particle diameter of the inorganic particles is within the above range, the function as a spacer can be effectively exhibited, and there is a tendency that hard caking of titanium oxide can be suppressed and the viscosity can be suppressed to be low. In addition, there is a tendency that the precipitation recovery property can be further improved.

The average particle diameter of the inorganic particles refers to the particle diameter of the particles in the inorganic particles at a cumulative 50% in a volume-based particle size distribution determined by a laser diffraction/scattering method. The average particle diameter is measured by a dynamic light scattering method or a laser diffraction method described in JIS Z8825. Specifically, a particle size distribution meter using a dynamic light scattering method as a measurement principle, for example, trade name “Microtrac UPA” manufactured by Nikkiso Co., Ltd. can be used.

The shape of the inorganic particles may be, for example, any of a spherical shape, a rod shape, a beaded shape in which spherical particles are connected in a row, a needle shape, and the like. Among these, from the viewpoint of effectively exhibiting the function as a spacer, a spherical shape or a rod shape is preferable, and a spherical shape is particularly preferable.

The shape of the inorganic particles can be checked by observation with a transmission electron microscope. In the present disclosure, present application, the term “spherical” means to such an extent as to exclude the case where a beaded shape in which primary particles are connected in a row, a rod shape, a needle shape, or the like is observed by a transmission electron microscope, and is not limited to a true sphere or an ellipsoidal sphere.

The content of the inorganic particles is not particularly limited, but is preferably equal to or more than 0.1% by mass, more preferably equal to or more than 0.3% by mass and equal to or less than 8% by mass, even more preferably greater than 0.5% by mass and equal to or less than 8% by mass, and particularly preferably greater than 0.5% by mass and equal to or less than 5% by mass with respect to the total amount of the radiation-curable ink jet composition.

The content of the inorganic particles is preferably equal to or more than 5% by mass and equal to or less than 20% by mass, and more preferably equal to or more than 7% by mass and equal to or less than 18% by mass with respect to the total mass of the titanium oxide. When the content of the inorganic particles is within the above range with respect to the total mass of the titanium oxide, the function as a spacer can be effectively exhibited, and there is a tendency that hard caking of the titanium oxide can be suppressed and the viscosity can be suppressed to be low. In addition, there is a tendency that the precipitation recovery property can be further improved.

### Polymerization Inhibitor

The radiation-curable ink jet composition according to the embodiment may contain a polymerization inhibitor for the purpose of suppressing the progress of an unintended polymerization reaction of the polymerizable compound during storage or the like and improving the storage stability of the ink composition.

The polymerization inhibitor is not particularly limited, and examples thereof include, for example, 4-methoxyphenol (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol), hindered amine compounds, and the like.

The above-described polymerization inhibitor may be used alone or in combination of two or more kinds thereof.

When the polymerization inhibitor is added, the content of the polymerization inhibitor contained in the ink composition is preferably equal to or more than 0.05% by mass and equal to or less than 1.00% by mass, and more preferably equal to or more than 0.05% by mass and equal to or less than 0.50% by mass with respect to the total amount of the radiation-curable ink jet composition. When the content of the polymerization inhibitor is within the above range, the storage stability of the ink composition tends to be further improved.

### Sensitizer

The radiation-curable ink jet composition according to the embodiment may contain a sensitizer for the purpose of absorbing radiation to be in an excited state and promoting generation of active species from the photopolymerization initiator.

Examples of sensitizers include amine compounds such as aliphatic amines, amines containing aromatic groups, piperidines, reaction products of epoxy resins and amines, and triethanolamine triacrylate, urea compounds such as allylthiourea and o-tolylthiourea, sulfur compounds such as sodium diethyl dithiophosphate and soluble salts of aromatic sulfinic acids, nitrile-based compounds such as N,N-diethyl-p-aminobenzonitrile, phosphorus compounds such as tri-n-butylphosphine and sodium diethyl dithiophosphide, nitrogen compounds such as Michler's ketone, N-nitrosohydroxylamine derivatives, oxazolidine compounds, tetrahydro-1,3-oxazine compounds, condensates of formaldehyde or acetaldehyde and diamine, and chlorine compounds such as carbon tetrachloride and hexachloroethane. The thioxanthone compound in the above-described photopolymerization initiator may be used as a sensitizer. Examples of the sensitizer include, for example, 2,4-diethylthioxanthone, and the like.

These sensitizers may be used alone or in combination of two or more kinds thereof.

When the sensitizer is added, the content of the sensitizer contained in the ink composition is preferably equal to or more than 0.5% by mass and equal to or less than 3.0% by mass with respect to the total amount of the radiation-curable ink jet composition. When the content of the sensitizer is within the above range, generation of active species from the photopolymerization initiator tends to be further promoted.

### Surfactant

The radiation-curable ink jet composition according to the embodiment may contain a surfactant for the purpose of improving the scratch resistance of the cured coating film of the ink composition.

The surfactant is preferably a silicone-based surfactant, and more preferably a polyester-modified silicone or a polyether-modified silicone. As these surfactants, commercially available products can be adopted, and examples thereof include polyester-modified silicones such as BYK (registered trademark)-347, -348, -350, BYK-UV3500, -3510, and -3530, and polyether-modified silicones such as BYK-3570, manufactured by BYK Additives & Instruments.

The above-mentioned surfactants may be used alone or in combination of two or more kinds thereof.

When the surfactant is added, the content of the surfactant contained in the ink composition is preferably equal to or more than 0.01% by mass and equal to or less than 2.00% by mass, and more preferably equal to or more than 0.05% by mass and equal to or less than 1.00% by mass with respect to the total amount of the radiation-curable ink jet composition. When the surfactant is within the above range, the scratch resistance of the cured coating film of the ink composition tends to be further improved.

### Dispersant

The radiation-curable ink jet composition according to the embodiment may contain a dispersant for the purpose of further improving the dispersibility of titanium oxide in the ink composition.

The dispersant is not particularly limited, and examples thereof include known dispersants commonly used in the preparation of pigment dispersion liquid, such as a polymer dispersant. Specific examples of the dispersant include those containing, as a main component, one or more kinds of polyoxyalkylene polyalkylene polyamines, vinyl-based polymers and copolymers, acrylic polymers and copolymers, polyesters, polyamides, polyimides, polyurethanes, amino-based polymers, silicon-containing polymers, sulfur-containing polymers, fluorine-containing polymers, and epoxy resins. The dispersant may be used alone or in combination of two or more kinds thereof.

As the polymer dispersant, a commercially available product may be used, and examples thereof include AJISPER (registered trademark) series manufactured by Ajinomoto Fine-Techno Co., Inc., Solsperse (registered trademark) series such as Solsperse 36000 manufactured by Lubrizol Corporation, DISPERBYK series manufactured by BYK Additives & Instruments, and DISPARLON (registered trademark) series manufactured by Kusumoto Chemicals, Ltd.

The content of the dispersant is preferably equal to or more than 0.05% by mass and equal to or less than 1.00% by mass, and more preferably equal to or more than 0.10% by mass and equal to or less than 0.50% by mass with respect to the total amount of the radiation-curable ink jet composition. When the content of the dispersant is within the above range, the dispersibility of titanium oxide tends to be further improved, and the precipitation recovery property tends to be further improved.

### 1.5. Method for Preparing Ink Composition

In the preparation of the ink composition, the various components described above are mixed and sufficiently stirred so that the various components are uniformly mixed. In the embodiment, in the preparation process, at least one of ultrasonic treatment and heating treatment is preferably performed on a mixture obtained by mixing the photopolymerization initiator and at least a part of the polymerizable compound. As a result, the dissolved oxygen in the prepared ink composition is reduced, and the discharge stability and storage stability are improved.

### 1.6. Physical Properties of Ink Composition

The viscosity of the ink composition at 20° C. is preferably equal to or more than 10 mPa·s (millipascal seconds) and equal to or less than 30 mPa·s, more preferably equal to or more than 10 mPa·s and equal to or less than 25 mPa·s, and still more preferably equal to or more than 10 mPa·s and equal to or less than 20 mPa·s. According to this configuration, an appropriate amount of the ink composition is discharged from the ink jet head, and it is possible to suppress curved flight and scattering of ink droplets. The viscosity of the ink composition is measured by increasing the shear rate from 10 to 1000 and reading the viscosity when the shear rate is 200 under an environment of 20° C. using a viscoelasticity tester “MCR-300” manufactured by Pysica.

The surface tension of the ink composition at 20° C. is preferably equal to or more than 20 mN/m and equal to or less than 40 mN/m. This makes it difficult for the ink composition to wet the nozzle surface of the ink jet head subjected to the liquid-repellent treatment. Therefore, an appropriate amount of the ink composition is normally discharged from the ink jet head, and it is possible to suppress curved flight and scattering of ink droplets. The surface tension of the ink composition is measured by checking the surface tension when a platinum plate is made to get wet with the ink composition under an environment of 20° C. using an automatic surface tensiometer CBVP-Z manufactured by Kyowa Interface Science Co., Ltd.

### 2. Ink Jet Method

An ink jet method according to an embodiment of the present disclosure is an ink jet method comprising: a discharging step of discharging the radiation-curable ink jet composition described above from an ink jet head onto a recording medium; and a curing step of irradiating the discharged radiation-curable ink jet composition with radiation to obtain a cured coating film of the radiation-curable ink jet composition, in which the maximum film thickness of the cured coating film is equal to or less than 15 μm.

According to the ink jet method of the embodiment, by using the radiation-curable ink jet composition described above, even when recording is performed with the maximum film thickness of the cured coating film being equal to or less than a specific thickness, sufficient shielding properties can be ensured, and the ink viscosity is suppressed to be low, and thus the discharge stability is excellent.

In the present disclosure, the “cured coating film” means a film formed by applying and curing a radiation-curable ink jet composition on a recording medium. The “maximum film thickness” means the largest film thickness among the film thicknesses of the cured coating film.

Hereinafter, the recording medium will be described first, and then the contents of each step will be described.

### 2.1. Recording Medium

The recording medium used in the ink jet method according to the embodiment may have a recording surface that absorbs the ink composition or may not have a recording surface that absorbs the ink composition. Therefore, the recording medium is not particularly limited, and examples thereof include a liquid absorbing recording medium such as paper, film, or cloth, a low liquid absorbing recording medium such as printing paper, and a non-liquid absorbing recording medium such as metal, glass, or polymer.

The low liquid absorbing or non-liquid absorbing recording medium refers to a recording medium having a property of absorbing no or little ink composition. Quantitatively, a non-liquid absorbing or low liquid absorbing recording medium refers to a “recording medium in which an amount of water absorbed from the start of contact to 30 msec^{1/2} is equal to or less than 10 mL/m² in the Bristow method”. The Bristow method is the most widespread method as a method for measuring an amount of liquid absorbed in a short time, and is also adopted by the Japan Technical Association of the Pulp and Paper Industry (JAPAN TAPPI). The details of the test method are described in Standard No. 51 “Paper and Paperboard-Liquid Absorbency Test Method-Bristow Method” of “JAPAN TAPPI Paper Pulp Test Method 2000 Edition”. On the other hand, the liquid absorbing recording medium indicates a recording medium which does not correspond to the non-liquid absorbing property and the low liquid absorbing property. In the present specification, low liquid absorbency and non-liquid absorbency may be simply referred to as low absorbency and no absorbency.

Examples of the non-liquid absorbing recording medium include, for example, a recording medium in which a plastic is coated on a substrate such as paper, a recording medium in which a plastic film is adhered to a substrate such as paper, a plastic film that does not have an absorbing layer (receiving layer), and the like. Examples of the plastic described herein include polyvinyl chloride, polyethylene terephthalate, polycarbonate, polystyrene, polyurethane, polyethylene, polypropylene, and the like.

Examples of the low liquid absorbing recording medium include a recording medium provided with a coating layer (receiving layer) for receiving a liquid such as an ink composition on the surface thereof, examples of the recording medium in which the substrate is paper include, for example, printing paper such as art paper, coated paper, and matte paper, in a case where the substrate is a plastic film, examples thereof include films in which a surface of polyvinyl chloride, polyethylene terephthalate, polycarbonate, polystyrene, polyurethane, polyethylene, polypropylene, or the like is coated with a hydrophilic polymer or the like, or coated with particles such as silica and titanium together with a binder.

The ink jet method according to the embodiment can be suitably used for a soft packaging film. The soft packaging film is an aspect of the above-described non-liquid absorbing recording medium. More specifically, the soft packaging film is a film material having high flexibility used for food packaging and toiletry, cosmetic packaging, or the like, and is a film material having antifogging properties or antistatic properties, and an antioxidant or the like present on the film surface, and having a thickness in the range of from 10 to 70 μm (preferably from 15 to 50 m). When an ink composition or the like is attached to this film, the ink composition is less likely to be fixed compared to a plastic film having a normal thickness, and the ink composition or the like is less likely to correspond to (follow) the flexibility of the film even after fixing, and peeling is likely to occur. However, according to the ink jet method of the embodiment, since the cured coating film of the ink composition has excellent shielding properties, the cured coating film can be thinned as a whole, and even a soft packaging film can be suitably used.

Examples of a material for forming the soft packaging film include polyester-based resins such as polyethylene terephthalate, polyamide-based resins such as nylon and aramid, polyolefin-based resins such as polyethylene and polypropylene, polycarbonate-based resins, polystyrene-based resins, and polyacetal-based resins. Among these forming materials, it is preferable that the soft packaging film contain any one of polyethylene terephthalate, polyolefin, and nylon from the viewpoint of versatility and availability.

As the soft packaging film, those obtained by processing these resins into a film or a sheet can be used. In the case of a film or sheet using resin, any of an unstretched film, a stretched film stretched in a uniaxial direction or a biaxial direction, and the like can be used, and it is preferable to use a film stretched in a biaxial direction. If necessary, films or sheets made of these various resins may be used in a laminated state.

In addition, the ink jet method according to the embodiment can also be suitably used for a recording medium for sign graphics. As described above, a recording medium for sign graphics, there are various materials such as banner, coated paper, matte paper, wall paper, cloth, plastic film such as PET and PVC, and the like, however, the ink jet method according to the embodiment can be particularly suitably used for a transparent or translucent plastic film used for a window display, car wrapping, or the like. These films that have a substrate made of flexible polyolefin, PET and PVC or the like and have an adhesive layer on the surface opposite to the printed surface are widely used, and are used by being attached to a window glass, a vehicle body or the like on the adhesive surface after printing. When an ink composition or the like is attached to the film, the ink composition is less likely to be fixed, and the ink composition or the like is less likely to correspond to (follow) the flexibility of the film even after fixing, and thus peeling is likely to occur. However, according to the ink jet method of the embodiment, since the cured coating film of the ink composition has excellent shielding properties, the cured coating film can be thinned as a whole, and even these films can be suitably used.

Examples of a material for forming a transparent or translucent plastic film for sign graphics include polyester-based resins such as polyethylene terephthalate, polyamide-based resins such as nylon and aramid, polyolefin-based resins such as polyethylene and polypropylene, polycarbonate-based resins, polystyrene-based resins, and polyacetal-based resins. Among these forming materials, any one of polyethylene terephthalate, polyolefin, and nylon is preferably contained from the viewpoint of versatility and availability.

### 2.2. Discharging Step

This step is a step of discharging the radiation-curable ink jet composition described above from an ink jet head to a recording medium. At this time, the ink composition is attached to the recording medium so that the thickness of the cured coating film of the ink composition formed in the curing step, which is a subsequent step, is equal to or less than 15 μm. As a result, a liquid layer of the ink composition is formed on the surface of the recording medium. Since the radiation-curable ink jet composition is as described above, detailed description thereof will be omitted.

As a unit that discharges the radiation-curable ink jet composition, for example, an ink jet recording apparatus described below can be used.

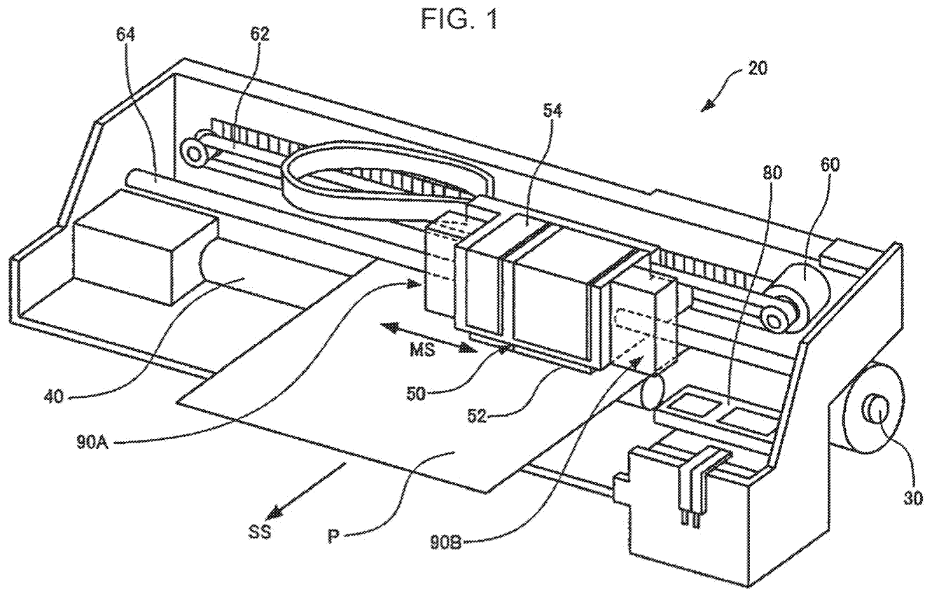

FIG. 1 is a perspective view of an ink jet recording apparatus that can be used in the ink jet method according to the embodiment.

An ink jet recording apparatus 20 illustrated in FIG. 1 includes a motor 30 that feeds a recording medium P in a sub-scanning direction SS, a platen 40, an ink jet head 52 as a recording head for ejecting a radiation-curable ink jet composition having a fine particle diameter from a head nozzle to discharge it to the recording medium P, a carriage 50 on which the ink jet head 52 is mounted, a carriage motor 60 that moves the carriage 50 in a main-scanning direction MS, and a pair of light irradiation devices 90A and 90B that irradiate an ink composition attached surface on the recording medium P to which the radiation-curable ink jet composition is discharged by the ink jet head 52.

The carriage 50 is pulled by a pulling belt 62 driven by the carriage motor 60 and moves along a guide rail 64.

The ink jet head 52 illustrated in FIG. 1 is a serial type head, and is provided with head nozzles. In addition to the ink jet head 52, an ink cartridge 54 containing an ink composition to be supplied to the ink jet head 52 is mounted on the carriage 50 on which the ink jet head 52 is mounted. The ink composition contained in the ink cartridge 54 is the radiation-curable ink jet composition described above.

At a home position (a position on the right side in FIG. 1) of the carriage 50, a capping device 80 for sealing a nozzle surface of the ink jet head 52 when the carriage 50 is stopped is provided. When the print job is completed and the carriage 50 reaches above the capping device 80, the capping device 80 is automatically raised by a mechanism (not illustrated) to seal the nozzle surface of the ink jet head 52. This capping prevents the ink composition in the nozzles from drying out. The positioning control of the carriage 50 is performed, for example, to accurately position the carriage 50 at the position of the capping device 80.

By using such the ink jet recording apparatus 20, the radiation-curable ink jet composition can be discharged onto a recording medium. Further, according to the ink jet recording apparatus 20, the discharging step and the curing step can be continuously performed by one apparatus without performing the discharging step and the curing step by separate apparatuses.

### 2.3. Curing Step

This step is a step of irradiating the discharged radiation-curable ink jet composition with radiation to obtain a cured coating film of the radiation-curable ink jet composition, and the maximum film thickness of the cured coating film is equal to or less than 15 μm.

As the radiation, ultraviolet rays, visible rays, and the like can be used, and it is more preferable that a radiation-curable ink jet composition that is cured by ultraviolet rays be used as the radiation-curable ink jet composition and be cured by using ultraviolet rays because curing of the ink composition by environmental light or the like can be suppressed and handling becomes easy. Examples of irradiation means capable of irradiating radiation include the light irradiation devices illustrated in FIG. 1 to FIG. 3.

Hereinafter, a case where the curing step is performed using the above-described ink jet recording apparatus 20 will be described in detail.

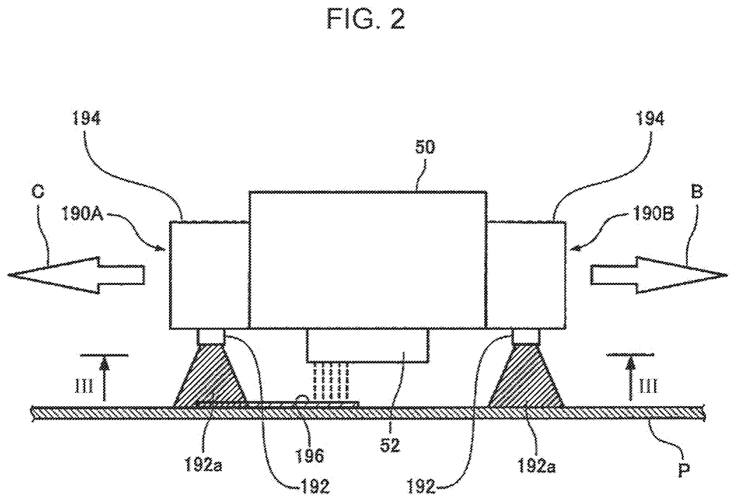

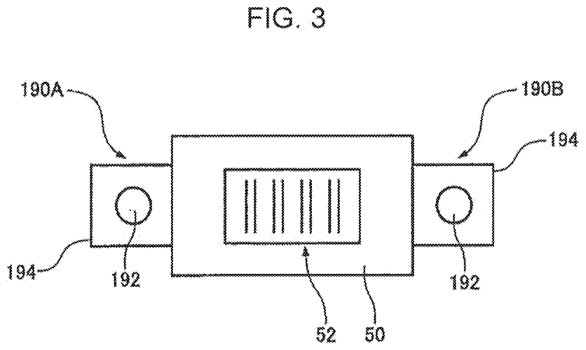

FIG. 2 is a front view of the light irradiation devices 90A (corresponding to 190A in FIG. 2) and 90B (corresponding to 190B in FIG. 2) illustrated in FIG. 1. FIG. 3 is an III-III arrow view of FIG. 2.

As illustrated in FIG. 1 to FIG. 3, the light irradiation devices 190A and 190B are attached to both side ends along a moving direction of the carriage 50.

As illustrated in FIG. 2, the light irradiation device 190A attached to the left side of the ink jet head 52 irradiates an ink layer 196 discharged on the recording medium P with radiation during right scanning in which the carriage 50 moves in the right direction (in the direction of an arrow B in FIG. 2). On the other hand, the light irradiation device 190B attached to the right side of the ink jet head 52 irradiates the ink layer 196 discharged on the recording medium P with radiation during left scanning in which the carriage 50 moves in the left direction (in the direction of an arrow C in FIG. 2).

Each of the light irradiation devices 190A and 190B includes a housing 194 that is attached to the carriage 50 and supports the light sources 192 one by one in alignment, and a light source control circuit (not illustrated) that controls light emission and light extinction of the light sources 192. As illustrated in FIG. 2 and FIG. 3, one light source 192 is provided at each of the light irradiation devices 190A and 190B, but two or more light sources may be provided. As the light source 192, either an LED or an LD is preferably used. This makes it possible to avoid an increase in the size of the radiation source due to the provision of a filter or the like, as compared with the case where a mercury lamp, a metal halide lamp, or other lamps are used as the radiation source. In addition, the radiation-curable ink jet composition can be efficiently cured without reduction in the intensity of the emitted radiation due to absorption by the filter.

Each of the light sources 192 may emit light having the same wavelength or light having different wavelengths. When an LED or an LD is used as the light source 192, the emission peak wavelength of the emitted radiation may be any of the range of from about 350 to 430 nm.

According to the light irradiation devices 190A and 190B described above, as illustrated in FIG. 2, the ink layer 196 attached onto the recording medium P by discharge from the ink jet head 52 is irradiated with radiation 192a by the light source 192 that irradiates the recording medium P in the vicinity of the ink jet head 52, and a surface and an inside of the ink layer 196 can be cured.

Although the illumination intensity of the radiation cannot be strictly specified because it varies depending on thicknesses of the ink layer 196 attached onto the recording medium P and preferable conditions are appropriately selected, sufficient curing can be performed at an illumination intensity from approximately 10 to 2000 mW/cm².

The configuration of the ink jet recording apparatus 20 is not limited to the configuration of the ink jet head, the carriage, the light source, and the like described above, and various forms can be adopted based on the gist of the ink jet method according to the embodiment.

### 3. Recorded Matter

A recorded matter according to an embodiment of the disclosure is obtained by the ink jet method described above. Such a recorded matter can ensure sufficient shielding properties even when the maximum film thickness of the cured coating film in the recorded matter is a specific thickness or less. In the present disclosure, the “recorded matter” means a matter obtained by recording an ink on a recording medium to form a cured product, and the cured product means a cured substance.

A recorded matter according to an embodiment of the present disclosure is a recorded matter in which a cured coating film of a radiation-curable ink jet composition is formed on a recording medium, in which the cured coating film contains titanium oxide particles having an average particle diameter of equal to or more than 250 nm and equal to or less than 400 nm, and the maximum film thickness of the cured coating film is equal to or less than 15 μm. Such recorded matter has excellent shielding properties even when the maximum film thickness of the cured coating film is a specific thickness or less, and can be used as, for example, a foundation layer. In addition, since the maximum film thickness of the cured coating film is a specific thickness or less, a soft packaging film or a transparent or translucent plastic film for sign graphics can be suitably used as the recording medium.

In addition to the titanium oxide particles, the cured coating film may contain components such as inorganic particles as a spacer described above.

The maximum film thickness of the cured coating film can be measured, for example, as follows. A slice sample or a cross-section sample is prepared using a microtome or the like, and the film thickness is measured using a microscope. Alternatively, the film thickness is measured non-destructively with a laser microscope. Any one of these operations is performed on five or more portions of the print region in which an amount of dot generation is 100% in the recorded matter, and the largest film thickness is set as the maximum film thickness.

### 4. Example

Hereinafter, the present disclosure will be described more specifically with reference to examples, but the present disclosure is not limited to these examples. Hereinafter, “%” is based on mass unless otherwise specified. In the composition columns of Table 1 and Table 2 below, the unit of numerical values is “composition ratio/g” (“% by mass”).

### 4.1. Preparation of Radiation-Curable Ink Jet Composition

First, titanium oxide, a dispersant (a part thereof in Examples 9 to 11), and a part of the polymerizable compound were weighed and placed in a tank for bead mill dispersion, and ceramic beads having a diameter of 1 mm were placed in the tank and stirred to obtain each titanium oxide dispersion liquid in which titanium oxide was dispersed in the polymerizable compound.

Subsequently, the remaining polymerizable compound, polymerization inhibitor, photopolymerization initiator, sensitizer, and surfactant were weighed into a stainless steel tank for mixture so as to have the composition shown in Table 1 or Table 2 below. Subsequently, after mixing and stirring using a mechanical stirrer to completely dissolve the mixture, and then the titanium oxide dispersion liquid obtained above was fed thereto, and the mixture was further mixed and stirred under an environment of about 20° C. for one hour. Thereafter, the mixture was filtered through a membrane filter having a pore size of 5 μm to obtain each ink composition.

In Examples 9 to 11, an inorganic particle dispersion liquid was prepared using the remaining dispersant in the same manner as in the preparation of the titanium oxide dispersion liquid. Thereafter, the inorganic particle dispersion liquid was fed at the timing when the titanium oxide dispersion liquid was fed into the tank for mixture, and the ink compositions of Examples 9 to 11 were obtained according to the above-described adjustment procedure.

TABLE 1

| | | Example 1 | Example 2 | Example 3 | Example 4 | Example 5 |
|---|---|---|---|---|---|---|
| Material | Material | Composition | Composition | Composition | Composition | Composition |
| species | name | ratio/g | ratio/g | ratio/g | ratio/g | ratio/g |
| Monofunctional | PEA | 26.00 | 22.97 | 20.95 | 31.05 | 20.95 |
| monomer A | | | | | | |
| Monofunctional | THFA | | | | | |
| monomer B | | | | | | |
| Polyfunctional | VEEA | 30.00 | 30.00 | 30.00 | 30.00 | 30.00 |
| monomer A | | | | | | |
| Polyfunctional | V#335HP | 15.00 | 15.00 | 15.00 | 15.00 | 15.00 |
| monomer B | | | | | | |
| Polyfunctional | SR444 | 5.00 | 5.00 | 5.00 | 5.00 | 5.00 |
| monomer C | | | | | | |
| Polymerization | MEHQ | 0.15 | 0.15 | 0.15 | 0.15 | 0.15 |
| inhibitor | | | | | | |
| Photopoly- | Omnirad 819 | 3.00 | 3.00 | 3.00 | 3.00 | 3.00 |
| merization | | | | | | |
| initiator A | | | | | | |
| Photopoly- | Speedcure TPO | 5.00 | 5.00 | 5.00 | 5.00 | 5.00 |
| merization | | | | | | |
| initiator B | | | | | | |
| Sensitizer A | Speedcure DETX | 0.50 | 0.50 | 0.50 | 0.50 | 0.50 |
| Surfactant | BYK 350 | 0.20 | 0.20 | 0.20 | 0.20 | 0.20 |
| Dispersant | BYK 180 | 0.15 | 0.18 | 0.20 | 0.10 | 0.20 |
| Inorganic | Silica | | | | | |
| particles | nanoparticles | | | | | |
| | 50 nm | | | | | |
| | Alumina | | | | | |
| | nanoparticles | | | | | |
| | 50 nm | | | | | |
| Titanium | TiO₂ particle | | | | | |
| oxide | diameter D50 | | | | | |
| | 200 nm | | | | | |
| | TiO₂ particle | | | | | |
| | diameter D50 | | | | | |
| | 250 nm | | | | | |
| | TiO₂ particle | 15.00 | 18.00 | 20.00 | 10.00 | 20.00 |
| | diameter D50 | | | | | |
| | 300 nm | | | | | |
| | TiO₂ particle | | | | | |
| | diameter D50 | | | | | |
| | 400 nm | | | | | |
| | TiO₂ particle | | | | | |
| | diameter D50 | | | | | |
| | 600 nm | | | | | |
| Total | | 100.00 | 100.00 | 100.00 | 100.00 | 100.00 |
| Solid film thickness | | 10 μm | 10 μm | 10 μm | 17 μm | 7 μm |
| Evaluation | Viscosity | A | A | B | A | B |
| | Precipitation | B | B | B | B | B |
| | recovery | | | | | |
| | Shielding | B | A | B | B | B |
| | properties | | | | | |
| | | Example 6 | Example 7 | Example 8 | Example 9 | Example 10 |
| Material | Material | Composition | Composition | Composition | Composition | Composition |
| species | name | ratio/g | ratio/g | ratio/g | ratio/g | ratio/g |
| Monofunctional | PEA | 15.90 | 20.95 | 20.95 | 18.95 | 17.95 |
| monomer A | | | | | | |
| Monofunctional | THFA | | | | | |
| monomer B | | | | | | |
| Polyfunctional | VEEA | 30.00 | 30.00 | 30.00 | 30.00 | 30.00 |
| monomer A | | | | | | |
| Polyfunctional | V#335HP | 15.00 | 15.00 | 15.00 | 15.00 | 15.00 |
| monomer B | | | | | | |
| Polyfunctional | SR444 | 5.00 | 5.00 | 5.00 | 5.00 | 5.00 |
| monomer C | | | | | | |
| Polymerization | MEHQ | 0.15 | 0.15 | 0.15 | 0.15 | 0.15 |
| inhibitor | | | | | | |
| Photopoly- | Omnirad 819 | 3.00 | 3.00 | 3.00 | 3.00 | 3.00 |
| merization | | | | | | |
| initiator A | | | | | | |
| Photopoly- | Speedcure TPO | 5.00 | 5.00 | 5.00 | 5.00 | 5.00 |
| merization | | | | | | |
| initiator B | | | | | | |
| Sensitizer A | Speedcure DETX | 0.50 | 0.50 | 0.50 | 0.50 | 0.50 |
| Surfactant | BYK 350 | 0.20 | 0.20 | 0.20 | 0.20 | 0.20 |
| Dispersant | BYK 180 | 0.25 | 0.20 | 0.20 | 0.20 | 0.20 |
| Inorganic | Silica | | | | 2.00 | 3.00 |
| particles | nanoparticles | | | | | |
| | 50 nm | | | | | |
| | Alumina | | | | | |
| | nanoparticles | | | | | |
| | 50 nm | | | | | |
| Titanium | TiO₂ particle | | | | | |
| oxide | diameter D50 | | | | | |
| | 200 nm | | | | | |
| | TiO₂ particle | | 20.00 | | | |
| | diameter D50 | | | | | |
| | 250 nm | | | | | |
| | TiO₂ particle | 25.00 | | | 20.00 | 20.00 |
| | diameter D50 | | | | | |
| | 300 nm | | | | | |
| | TiO₂ particle | | | 20.00 | | |
| | diameter D50 | | | | | |
| | 400 nm | | | | | |
| | TiO₂ particle | | | | | |
| | diameter D50 | | | | | |
| | 600 nm | | | | | |
| Total | | 100.00 | 100.00 | 100.00 | 100.00 | 100.00 |
| Solid film thickness | | 7 μm | 10 μm | 10 μm | 10 μm | 10 μm |
| Evaluation | Viscosity | B | B | B | B | B |
| | Precipitation | B | A | B | AA | AA |
| | recovery | | | | | |
| | Shielding | A | A | A | A | A |
| | properties | | | | | |

TABLE 2

| | | | | | Comparative | Comparative |
|---|---|---|---|---|---|---|
| | | Example 11 | Example 12 | Example 13 | Example 1 | Example 2 |
| Material | Material | Composition | Composition | Composition | Composition | Composition |
| species | name | ratio/g | ratio/g | ratio/g | ratio/g | ratio/g |
| Monofunctional | PEA | 18.95 | 20.00 | 10.95 | 20.95 | 10.85 |
| monomer A | | | | | | |
| Monofunctional | THFA | | 20.95 | | | |
| monomer B | | | | | | |
| Polyfunctional | VEEA | 30.00 | 10.00 | 50.00 | 30.00 | 30.00 |
| monomer A | | | | | | |
| Polyfunctional | V#335HP | 15.00 | 15.00 | 5.00 | 15.00 | 15.00 |
| monomer B | | | | | | |
| Polyfunctional | SR444 | 5.00 | 5.00 | 5.00 | 5.00 | 5.00 |
| monomer C | | | | | | |
| Polymerization | MEHQ | 0.15 | 0.15 | 0.15 | 0.15 | 0.15 |
| inhibitor | | | | | | |
| Photopoly- | Omnirad 819 | 3.00 | 3.00 | 3.00 | 3.00 | 3.00 |
| merization | | | | | | |
| initiator A | | | | | | |
| Photopoly- | Speedcure TPO | 5.00 | 5.00 | 5.00 | 5.00 | 5.00 |
| merization | | | | | | |
| initiator B | | | | | | |
| Sensitizer A | Speedcure DETX | 0.50 | 0.50 | 0.50 | 0.50 | 0.50 |
| Surfactant | BYK 350 | 0.20 | 0.20 | 0.20 | 0.20 | 0.20 |
| Dispersant | BYK 180 | 0.20 | 0.20 | 0.20 | 0.20 | 0.30 |
| Inorganic | Silica | | | | | |
| particles | nanoparticles | | | | | |
| | 50 nm | | | | | |
| | Alumina | 2.00 | | | | |
| | nanoparticles | | | | | |
| | 50 nm | | | | | |
| Titanium | TiO₂ particle | | | | 20.00 | 30.00 |
| oxide | diameter D50 | | | | | |
| | 200 nm | | | | | |
| | TiO₂ particle | | | | | |
| | diameter D50 | | | | | |
| | 250 nm | | | | | |
| | TiO₂ particle | 20.00 | 20.00 | 20.00 | | |
| | diameter D50 | | | | | |
| | 300 nm | | | | | |
| | TiO₂ particle | | | | | |
| | diameter D50 | | | | | |
| | 400 nm | | | | | |
| | TiO₂ particle | | | | | |
| | diameter D50 | | | | | |
| | 600 nm | | | | | |
| Total | | 100.00 | 100.00 | 100.00 | 100.00 | 100.00 |
| Solid film thickness | | 10 μm | 10 μm | 10 μm | 10 μm | 10 μm |
| Evaluation | Viscosity | B | B | A | B | C |
| | Precipitation | A | B | B | A | A |
| | recovery | | | | | |
| | Shielding | A | A | B | C | B |
| | properties | | | | | |

| | | Comparative | Comparative | Comparative | Comparative |
|---|---|---|---|---|---|
| | | Example 3 | Example 4 | Example 5 | Example 6 |
| Material | Material | Composition | Composition | Composition | Composition |
| species | name | ratio/g | ratio/g | ratio/g | ratio/g |
| Monofunctional | PEA | 20.95 | 31.05 | 20.95 | 40.95 |
| monomer A | | | | | |
| Monofunctional | THFA | | | | |
| monomer B | | | | | |
| Polyfunctional | VEEA | 30.00 | 30.00 | 30.00 | 0.00 |
| monomer A | | | | | |
| Polyfunctional | V#335HP | 15.00 | 15.00 | 15.00 | 25.00 |
| monomer B | | | | | |
| Polyfunctional | SR444 | 5.00 | 5.00 | 5.00 | 5.00 |
| monomer C | | | | | |
| Polymerization | MEHQ | 0.15 | 0.15 | 0.15 | 0.15 |
| inhibitor | | | | | |
| Photopoly- | Omnirad 819 | 3.00 | 3.00 | 3.00 | 3.00 |
| merization | | | | | |
| initiator A | | | | | |
| Photopoly- | Speedcure TPO | 5.00 | 5.00 | 5.00 | 5.00 |
| merization | | | | | |
| initiator B | | | | | |
| Sensitizer A | Speedcure DETX | 0.50 | 0.50 | 0.50 | 0.50 |
| Surfactant | BYK 350 | 0.20 | 0.20 | 0.20 | 0.20 |
| Dispersant | BYK 180 | 0.20 | 0.10 | 0.20 | 0.20 |
| Inorganic | Silica | | | | |
| particles | nanoparticles | | | | |
| | 50 nm | | | | |
| | Alumina | | | | |
| | nanoparticles | | | | |
| | 50 nm | | | | |
| Titanium | TiO₂ particle | 20.00 | 10.00 | | |
| oxide | diameter D50 | | | | |
| | 200 nm | | | | |
| | TiO₂ particle | | | | |
| | diameter D50 | | | | |
| | 250 nm | | | | |
| | TiO₂ particle | | | | 20.00 |
| | diameter D50 | | | | |
| | 300 nm | | | | |
| | TiO₂ particle | | | | |
| | diameter D50 | | | | |
| | 400 nm | | | | |
| | TiO₂ particle | | | 20.00 | |
| | diameter D50 | | | | |
| | 600 nm | | | | |
| Total | | 100.00 | 100.00 | 100.00 | 100.00 |
| Solid film thickness | | 6 μm | 17 μm | 10 μm | 10 μm |
| Evaluation | Viscosity | B | A | B | C |
| | Precipitation | A | A | C | B |
| | recovery | | | | |
| | Shielding | D | C | C | A |
| | properties | | | | |

The components shown in Table 1 and Table 2 will be supplementarily described.

Monofunctional Monomer

PEA: phenoxyethyl acrylate (trade name “Viscoat #192”, manufactured by Osaka Organic Chemical Industry Ltd.)

THFA: tetrahydrofurfuryl acrylate (trade name “Viscoat #150”, manufactured by Osaka Organic Chemical Industry Ltd.)

Polyfunctional Monomer

VEEA: 2-(2-vinyloxyethoxy)ethyl acrylate (trade name, manufactured by Nippon Shokubai Co., Ltd.)

V #335HP: tetraethylene glycol diacrylate (trade name “Viscoat #335HP”, manufactured by Osaka Organic Chemical Industry Ltd.)

SR444: pentaerythritol triacrylate (trade name, manufactured by Sartomer Company Inc.)

Polymerization Inhibitor

MEHQ: 4-methoxyphenol (manufactured by Kanto Chemical Co., Inc.)

Photopolymerization Initiator

Omnirad 819: bis(2,4,6-trimethylbenzoyl)-phenylphosphine oxide (trade name, manufactured by IGM RESINS B.V.)

Speedcure TPO: 2,4,6-trimethylbenzoyldiphenylphosphine oxide (trade name, manufactured by Lambson Group Ltd.)

Sensitizer

Speedcure DETX: 2,4-diethylthioxanthone (trade name, manufactured by Lambson Group Ltd.)

Surfactant

BYK350 (trade name, manufactured by BYK Japan K.K.)

Dispersant

BYK180 (trade name, manufactured by BYK Japan K.K.)

Inorganic Particles

Silica nanoparticle 50 nm (trade name “AEROSIL OX50”, manufactured by Evonik Industries AG)

Alumina nanoparticles 50 nm (trade name “1320DL”, manufactured by SkySpring Nanomaterials, Inc.)

Titanium Oxide

TiO₂ Particle Diameter D50 200 nm (trade name “R-680”, manufactured by Ishihara Sangyo Kaisha, Ltd.)

TiO₂ Particle Diameter D50 250 nm (trade name “CR-50”, manufactured by Ishihara Sangyo Kaisha, Ltd.)

TiO₂ Particle Diameter D50 300 nm (trade name “CR-93”, manufactured by Ishihara Sangyo Kaisha, Ltd.)

TiO₂ Particle Diameter D50 400 nm (trade name “R-38L”, manufactured by Sakai Chemical Industry Co., Ltd.)

TiO₂ Particle Diameter D50 600 nm (trade name “TA200”, manufactured by Fuji Titanium Industry Co., Ltd.)

In the inorganic particles, “silica nanoparticle 50 nm” means that the average particle diameter of the silica particles is 50 nm. Similarly, “alumina nanoparticles 50 nm” means that the average particle diameter of alumina particles is 50 nm.

In titanium oxide, “TiO₂ Particle Diameter D50 200 nm” means that the average particle diameter of titanium oxide is 200 nm. Similarly, in other descriptions, the average particle diameters of titanium oxide are respectively shown.

### 4.2. Production of Recorded Matter for Evaluation

The ink composition obtained above was placed in an ink cartridge of a printer manufactured by Seiko Epson Corporation (trade name “PX-G930”) modified such that a plastic film was used as a recording medium and a radiation-curable ink jet composition could be discharged (modified machine of trade name “PX-G930”), and printing was performed so as to obtain solid film thicknesses shown in Table 1 and Table 2. As the recording medium, a 20 μm-thick biaxially oriented polypropylene (OPP) film (trade name “FOA 20”) manufactured by Futamura Chemical Co., Ltd. was used. The “solid film thickness” refers to the thickness of an ink composition to be attached onto a recorded matter when dots are recorded for all pixels that are the minimum recording unit region defined by the recording resolution and normally, an image pattern that should be an image in which the recording region of the recording medium is covered with ink and the background of the recording medium is invisible is printed.

### 4.3. Evaluation Method

### 4.3.1. Viscosity Evaluation

The viscosity of each ink composition obtained as described above was evaluated. After the ink composition was prepared, the viscosity of the ink composition when one hour had elapsed was measured by increasing the shear rate from 10 to 1000 and reading the viscosity when the shear rate was 200 under an environment of 20° C. using a viscoelasticity tester “MCR-300” manufactured by Pysica, and was determined according to the following criteria.

Evaluation Criteria

A: less than 20 mPa·s

B: 20 or more and less than 25 mPa·s

C: 25 mPa·s or more

### 4.3.2. Evaluation of Precipitation Recovery Property Ink Pack Preparation

Each ink composition 600 ml obtained as described above was injected from a filling port into a pack in which four sides other than an ink filling port of a rectangle having a size of 30×15 cm in an empty state were heat-sealed, and each ink pack was prepared by heat-sealing the filling port so that no air remained in the pack. As the pack, an ethylene-vinyl alcohol copolymer film (0.1 mm thick) was used.

### Precipitation Recovery Property

The ink pack produced as described above was allowed to stand at room temperature (25° C.) for one year while a surface of the rectangle was horizontal. The ink composition in the ink pack after being allowed to stand was moved back and forth 50 times at a speed of 50 cm/sec in a direction of the long side of the rectangle with a swing width of 5 cm on both sides while the surface of the rectangle was horizontal, the ink composition was further moved back and forth 50 times while the surface of the rectangle was turned upside down and the surface thereof was horizontal in the same manner to be stirred, then the ink in an upper part of the pack was collected with the ink filling port of the pack facing upward, and absorbance (Abs) of the ink composition and absorbance of the ink composition before being allowed to stand were measured by an absorption spectrometer (trade name, U-3300 spectrophotometer manufactured by Hitachi, Ltd.). The rate of change in absorbance was calculated from the measured values and was evaluated according to the following evaluation criteria.

Evaluation Criteria

AA: 0% or more and less than 10%

A: 10% or more and less than 20%

B: 20% or more and less than 30%

C: 30% or more

### 4.3.3. Evaluation of Shielding Property

In the recorded matter obtained as described above, transmittance was measured with a deflection angle colorimeter (trade name “V550 UV/VIS Spectrophotometer”, manufactured by JASCO Corporation) to determine S800, and was evaluated according to the following criteria. Here, the “S800” refers to an integral value of the transmittance (%) from 380 to 800 nm, and a smaller value means a higher shielding property.

Evaluation Criteria

A: S800 is less than 150

B: S800 is 150 or more and less than 250

C: S800 is 250 or more and less than 350

D: S800 is 350 or more

### 4.4. Evaluation Result

The results of the evaluation tests are shown in Table 1 and Table 2 above.

From the evaluation results described above, in Examples 1 to 13, sufficient shielding properties were able to be obtained even when the film thickness of the cured coating film formed on the recording medium was thin, and the viscosity of the ink composition could be suppressed to be low.

On the other hand, in Comparative Examples 1 to 5 in which the average particle diameter of titanium oxide was not within the specific range, the shielding properties were lower than those in Examples and sufficient shielding properties could not be obtained, or the viscosity was high and the viscosity could not be suppressed to be low. In addition, in Comparative Example 6 in which the specific polymerizable compound was not contained, the viscosity was higher than those in Examples, and the viscosity could not be suppressed to be low.

The following is derived from the embodiments described above.

An aspect of the radiation-curable ink jet composition is a radiation-curable ink jet composition including titanium oxide, a polymerizable compound, and a photopolymerization initiator, the titanium oxide has an average particle diameter of equal to or more than 250 nm and equal to or less than 400 nm, and the polymerizable compound contains a vinyl group-containing (meth)acrylate represented by the following formula (I).

H₂C═CR¹—CO—OR²—O—CH═CH—R³ (I)

(wherein R¹ represents a hydrogen atom or a methyl group, R² represents a divalent organic residue having 2 to 20 carbon atoms, and R³ represents a hydrogen atom or a monovalent organic residue having 1 to 11 carbon atoms.)

In the aspect of the radiation-curable ink jet composition above, the content of the titanium oxide may be equal to or less than 20% by mass with respect to the total amount of the radiation-curable ink jet composition.

In the aspect of the radiation-curable ink jet composition, the radiation-curable ink jet composition may further contain inorganic particles.

In the aspect of the radiation-curable ink jet composition, the average particle diameter of the inorganic particles with respect to the average particle diameter of the titanium oxide may be equal to or more than 15% and less than 30%, and the content of the inorganic particles may be equal to or more than 5% by mass and equal to or less than 20% by mass with respect to the total mass of the titanium oxide.

In the aspect of the radiation-curable inkjet composition, the content of the vinyl group-containing (meth)acrylate represented by the formula (I) may be equal to or more than 10% by mass and equal to or less than 50% by mass with respect to the total amount of the radiation-curable ink jet composition.

An aspect of the ink jet method is an ink jet method including: a discharging step of discharging the radiation-curable ink jet composition of the aspect from an ink jet head to a recording medium; and a curing step of irradiating the discharged radiation-curable ink jet composition with radiation to obtain a cured coating film of the radiation-curable ink jet composition, in which the maximum film thickness of the cured coating film is equal to or less than 15 μm.

An aspect of the recorded matter is a recorded matter in which a cured coating film of a radiation-curable ink jet composition is formed on a recording medium, in which the cured coating film contains titanium oxide particles having an average particle diameter of equal to or more than 250 nm and equal to or less than 400 nm, and the maximum thickness of the cured coating film is equal to or less than 15 μm.

The present disclosure is not limited to the above-described embodiment, and various modifications are possible. For example, the disclosure includes a configuration substantially the same as the configuration described in the embodiment, for example, a configuration having the same function, method, and result, or a configuration having the same object and effect. In addition, the disclosure includes a configuration in which a non-essential portion of the configuration described in the embodiment is replaced. In addition, the disclosure includes a configuration having the same effect or a configuration capable of achieving the same object as the configuration described in the embodiment. In addition, the disclosure includes a configuration in which a known technique is added to the configuration described in the embodiment.

What is claimed is:

1. A radiation-curable ink jet composition comprising titanium oxide, a polymerizable compound, and a photopolymerization initiator,
wherein an average particle diameter of the titanium oxide is equal to or more than 250 nm and equal to or less than 400 nm, and
the polymerizable compound contains a vinyl group-containing (meth)acrylate represented by the following formula (I).
H₂C═CR¹—CO—OR²—O—CH═CH—R³ (I)
(wherein R¹ represents a hydrogen atom or a methyl group, R² represents a divalent organic residue having 2 to 20 carbon atoms, and R³ represents a hydrogen atom or a monovalent organic residue having 1 to 11 carbon atoms.)

2. The radiation-curable ink jet composition according to claim 1,
wherein a content of the titanium oxide is equal to or less than 20% by mass with respect to a total amount of the radiation-curable ink jet composition.

3. The radiation-curable ink jet composition according to claim 1, further comprising inorganic particles.

4. The radiation-curable ink jet composition according to claim 3,
wherein an average particle diameter of the inorganic particles with respect to an average particle diameter of the titanium oxide is equal to or more than 15% and less than 30%, and
a content of the inorganic particles is equal to or more than 5% by mass and equal to or less than 20% by mass with respect to a total mass of the titanium oxide.

5. The radiation-curable ink jet composition according to claim 1,
wherein a content of a vinyl group-containing (meth)acrylate represented by the formula (I) is equal to or more than 10% by mass and equal to or less than 50% by mass with respect to a total amount of the radiation-curable ink jet composition.

6. An ink jet method comprising:
a discharging step of discharging the radiation-curable ink jet composition according to claim 1 from an ink jet head to a recording medium; and
a curing step of irradiating the discharged radiation-curable ink jet composition with radiation to obtain a cured coating film of the radiation-curable ink jet composition,
wherein a maximum film thickness of the cured coating film is equal to or less than 15 μm.

7. The ink jet method according to claim 6,
wherein the recording medium includes any one of polyethylene terephthalate, polyolefin, and nylon.

8. A recorded matter in which a cured coating film of a radiation-curable ink jet composition is formed on a recording medium,
wherein the cured coating film contains titanium oxide particles having an average particle diameter of equal to or more than 250 nm and equal to or less than 400 nm, and
a maximum film thickness of the cured coating film is equal to or less than 15 μm.
